(19) United States
(12) Patent Application Publication
(10) Pub. No.: US 2014/0200048 A1
(43) Pub. Date: Jul. 17, 2014

(54) METHOD OF AUTOMATIC SIM CARD SELECTION ACCORDING TO NETWORK ENVIRONMENT

(71) Applicant: ACER INCORPORATED, New Taipei City (TW)

(72) Inventor: Tsung-Yo Cheng, New Taipei City (TW)

(21) Appl. No.: 13/920,090

(22) Filed: Jun. 18, 2013

Related U.S. Application Data
(60) Provisional application No. 61/753,443, filed on Jan. 17, 2013.

(51) Int. Cl. H04B 1/38

(52) U.S. Cl. CPC H04B 1/3816
USPC 455/558

(57) ABSTRACT

A method of automatic SIM card selection on a multi-SIM user equipment according to network environment is provided. When the user equipment leave its current communication range and enters a new communication range, one or more RATs are used to scan the new communication range and the identity information of each SIM card is compared with the PLMN identification of each scanned PLMN. If a match can be found, the matching SIM card is automatically set as the primary SIM in order to avoid roaming charge.

### CROSS REFERENCE TO RELATED APPLICATIONS

This application claims the benefit of U.S. provisional application No. 61/753,443 filed on Jan. 17, 2013.

### BACKGROUND OF THE INVENTION

1. Field of the Invention

The present invention is related to a method of operating a multi-SIM user equipment, and more particularly, to a method of automatic SIM card selection on a multi-SIM user equipment according to network environment.

2. Description of the Prior Art

A dual-SIM mobile phone is a cell phone capable of equipping two Subscriber Identity Module (SIM) cards, which correspond to different phone numbers. The dual SIM mobile phone with two radio transceivers allows a user to access two cellular networks for communication services without having to carry two phones. The mobile phone can establish two wireless communication bearers, either circuit switch or packet switch, between user and network controllers at the same time. For example, the same mobile phone may be used for both business and private use with separate numbers and billings, thus providing convenience to mobile phone users.

Traditional voice calls are routed over circuit-switched networks operated by service providers. A mobile phone that has roaming privileges can roam into any network. Roaming calls are routed from the current visiting location of the mobile phone to any number in the world. However, additional fees are usually applied to calls made and/or received while the phone is roaming. With the imposition of such roaming fees, the cost of calls when a wireless device is roaming is typically considerably higher than for calls when the device is in its home area.

Dual-SIM mobile phone users are often required to manually switch between SIM cards. In addition to inconvenient user experiences, unnecessary roaming charges may be generated due to wrong judgment of the user. Therefore, there exists a need for a method of reducing the roaming cost of multi-SIM mobile devices.

### SUMMARY OF THE INVENTION

The present invention provides a method of automatic SIM card selection on a user equipment according to network environment. The user equipment includes a plurality of SIM cards. The method includes scanning a second communication range using a first RAT for acquiring a first PLMN identification of a first PLMN after the user equipment leaves a first communication range and enters the second communication range; setting a first SIM card of the user equipment as a primary SIM card and camping on the first PLMN using the first RAT if identity information of the first SIM card matches the PLMN identification of the first PLMN; scanning the second communication range using a second RAT for acquiring a second PLMN identification of a second PLMN if identity information of all SIM cards of the user equipment does not match the PLMN identification of the first PLMN; and setting a second SIM card of the user equipment as the primary SIM card and camping on the second PLMN using the second RAT if identity information of the second SIM card matches the PLMN identification of the second PLMN.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1 and 2 are flowcharts illustrating a method of automatic SIM card selection on a UE according to embodiments of the present invention.

### DETAILED DESCRIPTION

The present invention provides a method of automatic SIM card selection on a user equipment (UE) according to network environment. The UE may be a dual-SIM or multi-SIM electronic device capable of containing multiple types of SIM cards, such as SIM card for GSM network, universal SIM (USIM) card for universal mobile telecommunications system (UMTS) network, or removable user identity module (R-UIM) and code division multiple access (CDMA) subscriber identity module (CSIM) card for CDMA network. The GSM SIM card typically contains user account information, an international mobile subscriber identity (IMSI) and a set of SIM application toolkit (SAT) commands and provides storage space for phone book contacts. The USIM card typically contains user account information, an IMSI, authentication information and a set of USIM Application Toolkit (USAT) commands and provides storage space for text messages and phone book contacts. The R-UIM or the CSIM card is physically compatible with the GSM SIM card, and provides similar security mechanisms for the CDMA system.

The technical specification 3GPP TS 31.102 prepared by the group of 3rd Generation Partnership Project (3GPP) proposes a priority configuration of a radio access technology (RAT) in which one or more RATs are made associated with one public land mobile network (PLMN). According to this, a UE grants a priority to the RAT that has the highest priority to search for a network present in the environment every time it loses network coverage. A communication company or a subscriber can set a priority level in the SIM card. A PLMN associated with a radio access technology set by the communication company is specified by an Operator PLMN (OPLMN), and a PLMN associated with a radio access technology set by the user is specified by a User PLMN (UPLMN). Priority setting is stored in each SIM card of the UE.

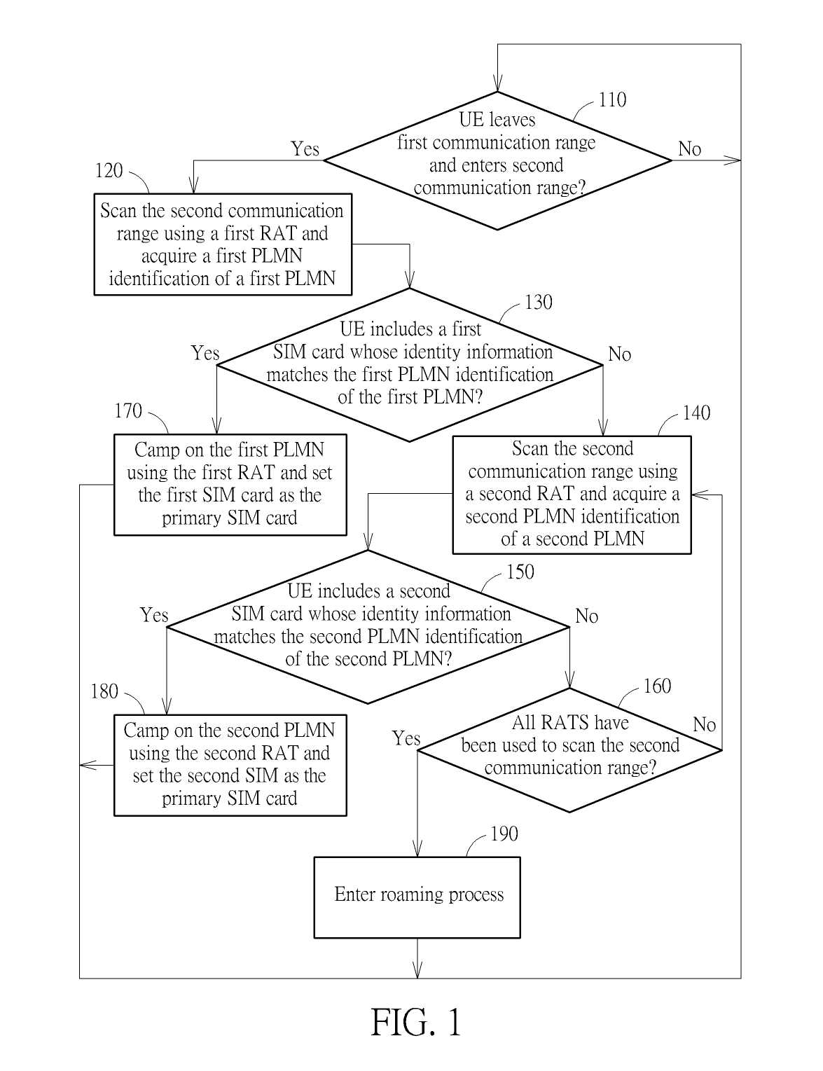

FIG. 1 is a flowchart illustrating a method of automatic SIM card selection on a UE according to an embodiment of the present invention. FIG. 1 includes the following steps:

Step 110: determine if the UE leaves a first communication range and enters a second communication range; if yes, execute step 120; if no, execute step 110.

Step 120: scan the second communication range using a first RAT and acquire a first PLMN identification of a first PLMN, execute step 130.

Step 130: determine if the UE includes a first SIM card whose identity information matches the first PLMN identification of the first PLMN; if yes, execute step 170; if no, execute step 140.

Step 140: scan the second communication range using a second RAT and acquire a second PLMN identification of a second PLMN; execute step 150.

Step 150: determine if the UE includes a second SIM card whose identity information matches the second PLMN identification of the second PLMN; if yes, execute step 180; if no, execute step 160.

Step 160: determine if all RATS indicated by the priority setting of each SIM card have been used to scan the second communication range; if yes, execute step 190; if no, execute step 140.

Step 170: camp on the first PLMN using the first RAT and set the first SIM card as the primary SIM card; execute step 110.

Step 180: camp on the second PLMN using the second RAT and set the second SIM as the primary SIM card; execute step 110.

Step 190: enter roaming process; execute step 110.

Before step 110, the UE may be camping on a network PLMN which may be UE's home PLMN (HPLMN), equivalent home PLMN (HPLMN) or visited home PLMN (VPLMN) selected in automatic mode or manual mode, as described in the technical specification 3GPP TS. 23.122.

In step 110, it is determined if the UE leaves the first communication range and enters the second communication range. The first and second communication ranges may be different location areas (LA), different routing areas (RA) or different countries.

In step 120, the UE is configured to scan the second communication range using the first RAT, which may have the highest priority according to the priority setting of the current primary SIM card. The first PLMN identification may include a mobile country code (MCC) and a mobile network code (MNC), which together uniquely identify the first PLMN in the second communication range.

In Step 130, the UE is configured to compare the identity information (such as IMSI) of each SIM card with the first PLMN identification of the first PLMN. If the first SIM card is a match, step 170 is then executed for camping on the first PLMN using the first RAT. The first SIM card is then automatically set as the primary SIM before the user leaves the second communication range. Therefore, a local charge may be enjoyed, and generating a roaming charge may be avoided.

In step 140, the UE is configured to scan the second communication range using the second RAT if the UE does not include any SIM card whose identity information (such as IMSI) matches the first PLMN identification of the first PLMN in step 130. The second RAT may be a unused RAT indicated by any of the SIM cards, such as the one having the second highest priority according to the priority setting of the current primary SIM card, or the one having the highest priority according to the priority setting of another SIM card. The second PLMN identification may include an MCC and an MNC, which together uniquely identify the second PLMN in the second communication range.

In Step 150, the UE is configured to compare the identity information (such as IMSI) of each SIM card with the second PLMN identification of the second PLMN. If the second SIM card is a match, step 180 is then executed for camping on the second PLMN using the second RAT. The second SIM card is then automatically set as the primary SIM before the user leaves the second communication range. Therefore, a local charge may be enjoyed, and generating a roaming charge may be avoided.

In step 160, the UE is configured to scan the second communication range using all available RATs before finding a match between a SIM IMSL and a network PLMN. If no match can be found after using all RATS indicated by the priority setting of each SIM card, step 190 is then executed for entering roaming process. The UE may set any of its SIM card as the primary card randomly, according to a predetermined rule, or based on user selection.

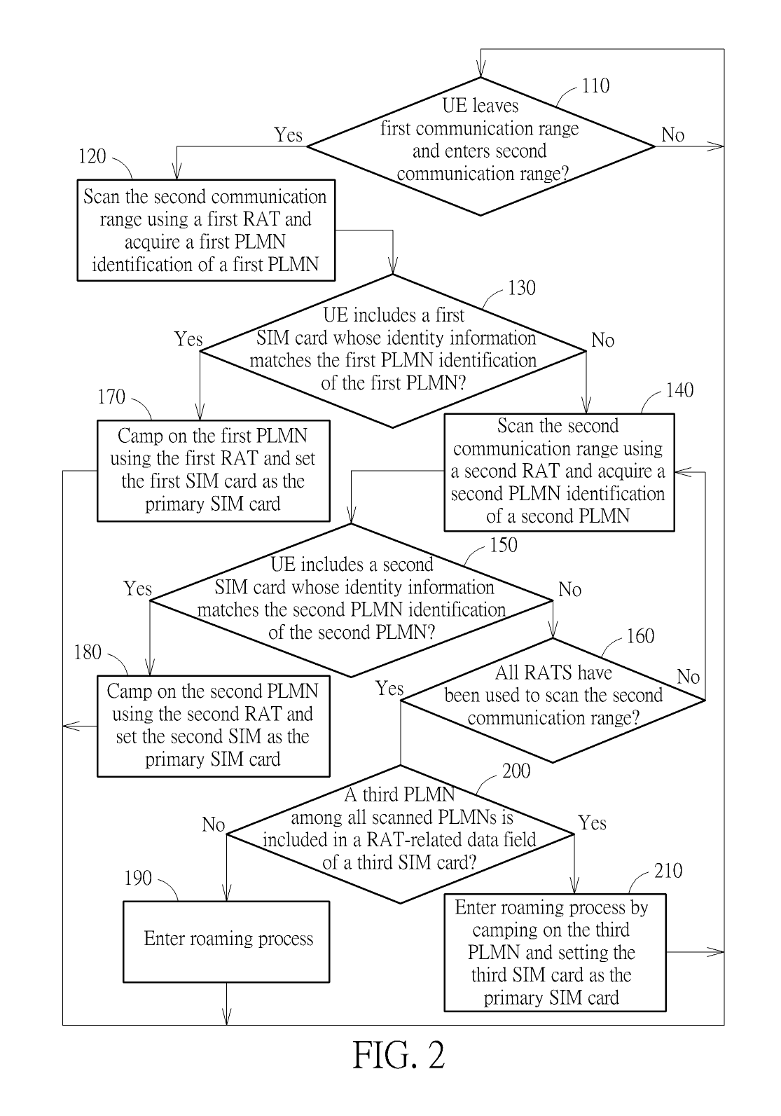

FIG. 2 is a flowchart illustrating a method of automatic SIM card selection on a UE according to another embodiment of the present invention. FIG. 2 includes the following steps:

Step 110: determine if the UE leaves a first communication range and enters a second communication range; if yes, execute step 120; if no, execute step 110.

Step 120: scan the second communication range using a first RAT and acquire a first PLMN identification of a first PLMN, execute step 130.

Step 130: determine if the UE includes a first SIM card whose identity information matches the first PLMN identification of the first PLMN; if yes, execute step 170; if no, execute step 140.

Step 140: scan the second communication range using another RAT and acquire a second PLMN identification of a second PLMN; execute step 150.

Step 150: determine if the UE includes a second SIM card whose identity information matches the second PLMN identification of the second PLMN; if yes, execute step 180; if no, execute step 160.

Step 160: determine if all RATS indicated by the priority setting of each SIM card have been used to scan the second communication range; if yes, execute step 200; if no, execute step 140.

Step 170: camp on the first PLMN using the first RAT and set the first SIM card as the primary SIM card; execute step 110.

Step 180: camp on the second PLMN using the first RAT and set the first SIM as the primary SIM card; execute step 110.

Step 190: enter roaming process; execute step 110.

Step 200: determine if a third PLMN among all scanned PLMNs is included in a RAT-related data field of a third SIM card; if yes, execute step 210; if no, execute step 190.

Step 210: enter roaming process by camping on the third PLMN and setting the third SIM card as the primary SIM card; execute step 110.

In the embodiment illustrated in FIG. 2, steps 110-190 may be executed in the same manner as FIG. 1. FIG. 2 further includes steps 200 and 210. If no match can be found after using all RATS indicated by the priority setting of each SIM card in step 160, step 200 is then executed in the embodiment illustrated in FIG. 2.

In step 200, the UE is configured to verify if any of the scanned PLMNs has roaming agreement with the service provider of any of its SIM card. This can be done by reading a RAT-related data field as defined in the technical specification 3GPP TS. 23.122, such as “HPLMN Selector with Access Technology”, “Operator Controlled PLMN Selector with Access Technology”, “User Controlled PLMN Selector with Access Technology”, or “Equivalent HPLMN”. If the third PLMN is included in any of the RAT-related data field of the third SIM card, the service provider of the third PLMN is likely to have roaming agreement with the service provider of the third SIM card, thereby providing reduced roaming fees. Step 210 is then executed for entering roaming process by camping on the third PLMN and setting the third SIM card as the primary SIM. Therefore, even if a local charge can not be enjoyed, the present invention can still reduce roaming charge.

In the present invention, the first SIM card, the second SIM card, or the third SIM card refers to one of the SIM cards plugged inside the UE. The terms “first”, “second” and “third” do not intend to imply sequential or different SIM cards.

In the present invention, when the UE leave its current communication range and enters a new communication range, one or more RATs are used to scan the new communication range and the identity information of each SIM card is compared with the PLMN identification of each scanned PLMN. If a match can be found, the matching SIM card is automatically set as the primary SIM in order to avoid roaming charge. If no match can be found but the service provider of a specific PLMN has roaming agreement with the service provider of a specific SIM card, the specific SIM card is automatically set as the primary SIM in order to reduce roaming charge.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of automatic Subscriber Identity Module (SIM) card selection on a user equipment according to network environment, the user equipment including a plurality of SIM cards, the method comprising:
scanning a second communication range using a first radio access technology (RAT) for acquiring a first public land mobile network (PLMN) identification of a first PLMN after the user equipment leaves a first communication range and enters the second communication range;
setting a first SIM card of the user equipment as a primary SIM card and camping on the first PLMN using the first RAT if identity information of the first SIM card matches the PLMN identification of the first PLMN;
scanning the second communication range using a second RAT for acquiring a second PLMN identification of a second PLMN if identity information of all SIM cards of the user equipment does not match the PLMN identification of the first PLMN; and
setting a second SIM card of the user equipment as the primary SIM card and camping on the second PLMN using the second RAT if identity information of the second SIM card matches the PLMN identification of the second PLMN.

2. The method of claim 1, wherein:
the second SIM card includes a priority setting associated with the second RAT.

3. The method of claim 1, further comprising:
determine if the first PLMN is included in a RAT-related data field of the first SIM card or the second SIM card if the identity information of the first and second SIM cards does not match the PLMN identification of the first and second PLMNs; and
the user equipment entering a roaming process by:
camping on the first PLMN and setting the first SIM card as the primary SIM card if the first PLMN is included in the RAT-related data field of the first SIM card; or
camping on the first PLMN and setting the second SIM card as the primary SIM card if the first PLMN is included in the RAT-related data field of the second SIM card.

4. The method of claim 3, wherein the RAT-related data field of the first SIM card or the second SIM card is an “HPLMN Selector with Access Technology” data field, an “Operator Controlled PLMN Selector with Access Technology” data field, a “User Controlled PLMN Selector with Access Technology” data field or an “Equivalent HPLMN” data field according to a 3rd Generation Partnership Project (3GPP) technical specification TS. 23.122.

5. The method of claim 1, further comprising:
determine if the second PLMN is included in a RAT-related data field of the first SIM card or the second SIM card if the identity information of the first and second SIM cards does not match the PLMN identification of the first and second PLMNs; and
the user equipment entering a roaming process by:
camping on the second PLMN and setting the first SIM card as the primary SIM card if the second PLMN is included in the RAT-related data field of the first SIM card; or
camping on the second PLMN and setting the second SIM card as the primary SIM card if the second PLMN is included in the RAT-related data field of the second SIM card.

6. The method of claim 5, wherein the RAT-related data field of the first SIM card or the second SIM card is an “HPLMN Selector with Access Technology” data field, an “Operator Controlled PLMN Selector with Access Technology” data field, a “User Controlled PLMN Selector with Access Technology” data field or an “Equivalent HPLMN” data field according to a 3GPP technical specification TS. 23.122.

7. The method of claim 1, wherein the first and second communication ranges are different location areas (LA), different routing areas (RA) or different countries.

8. The method of claim 1, wherein:
the first PLMN identification includes a mobile country code and a mobile network code for uniquely identifying the first PLMN in the second communication range; and
the second PLMN identification includes a mobile country code and a mobile network code for uniquely identifying the second PLMN in the second communication range.

9. The method of claim 1, wherein the identity information of the first or second SIM card is an international mobile subscriber identity (IMSI).
